(19) United States
(12) Patent Application Publication
(10) Pub. No.: US 2024/0222754 A1
(43) Pub. Date: Jul. 4, 2024

(54) CYLINDRICAL BATTERY AND ELECTRONIC DEVICE

(71) Applicant: AESC Japan Ltd., Kanagawa (JP)

(72) Inventor: Yonggang Xu, Jiangsu (CN)

(73) Assignee: AESC Japan Ltd., Kanagawa (JP)

(21) Appl. No.: 18/305,372

(22) Filed: Apr. 23, 2023

(30) Foreign Application Priority Data
Dec. 29, 2022 (CN) 202223550269.6

(51) Int. Cl. H01M 50/184; H01M 50/107; H01M 50/152; H01M 50/186

(52) U.S. Cl. CPC H01M 50/184; H01M 50/107; H01M 50/152; H01M 50/186

(57) ABSTRACT

A cylindrical battery including a housing, a cell, a cover, and a sealing member is provided. The cell includes a cell body and a first tab. The cover is electrically connected to the first tab, and a protruding portion is provided on the cover. The sealing member is provided with an avoidance hole for the protruding portion to protrude from, and the protruding portion on the cover is able to reach out through the avoidance hole on the sealing member to be in direct contact with a surrounding wall, thereby ensuring that the cover is electrically connected to the surrounding wall of the housing.

### CROSS-REFERENCE TO RELATED APPLICATION

This application claims the priority benefit of China application no. 202223550269.6, filed on Dec. 29, 2022. The entirety of the above-mentioned patent application is hereby incorporated by reference and made a part of this specification.

### BACKGROUND

### Technical Field

The disclosure relates to the technical field of batteries, in particular to a cylindrical battery and an electronic device.

### Description of Related Art

Characterized in high energy density, high safety and low cost, cylindrical battery is now an important topic for research in the field of new energy power batteries. A cylindrical battery includes a housing, a cell, an electrode pole and a cover. The housing is a cylindrical structure with one end open. The housing includes an end wall and a surrounding wall enclosing the end wall. The cell is provided in the housing. The cover seals the open end of the housing. The first tab of the cell is welded to the housing through a connecting piece, and the electrode pole is fixed on the end wall of the housing and electrically connected with the second tab of the cell.

In the related art, the packaging process of the cylindrical battery is as follows: after the cell is loaded into the housing, one end of the housing away from the electrode pole is pier-sealed, and the connecting piece is welded and fixed to the surrounding wall of the housing to realize electrical connection between the tab and the housing. If the welding between the connecting piece and the housing is performed in the housing, the metal shavings generated during the welding process are very likely to fall within the cell, which will affect the safety of the cell; if the welding between the connecting piece and the housing is performed outside the housing, since the position where the housing and the connecting piece correspond each other is generally close to the position where the housing is pier-sealed, as the surrounding wall of the housing is stretched and thinned after the pier-sealing treatment, if penetration welding is performed outside the housing, it is likely to cause the surrounding wall of the housing to crack, and electrolyte leakage will occur consequently.

In light of the above, it is an urgent issue to provide a cylindrical battery to solve the above problems.

### SUMMARY

A purpose of the present disclosure is to provide a cylindrical battery, which is able to avoid electrolyte leakage and improve the stability and safety of the cylindrical battery.

Another purpose of the present disclosure is to provide an electronic device, and the stability and safety of the electronic device may be improved by using the above-mentioned cylindrical battery.

In order to achieve the above purpose, the following technical solutions are provided:

In the first aspect, a cylindrical battery is provided, which includes: a housing, which includes an opening; a cell, which includes a cell body and a first tab, and the first tab is located at one end of the cell body; a cover, the cover is electrically connected to the first tab, and a protruding portion is provided on the cover; a sealing member, which covers the edge of the cover, the sealing member is provided with an avoidance hole for the protruding portion to protrude from, and the protruding portion on the cover is able to reach out through the avoidance hole on the sealing member to be in direct contact with the housing.

In an optional solution for the cylindrical battery, the sealing member includes a first wrapping portion and a second wrapping portion, the first wrapping portion covers the outer surface of the cover, and the second wrapping portion covers the inner surface of the cover.

In an optional solution for the cylindrical battery, a plurality of protruding portions are arranged on the outer surface of the cover at intervals along the circumferential direction of the cover, and a plurality of avoidance holes are arranged on the first wrapping portion of the sealing member at intervals along the circumferential direction of the sealing member.

In an optional solution for the cylindrical battery, a plurality of the protruding portions are arranged on the inner surface of the cover at intervals along the circumferential direction of the cover, and a plurality of the avoidance holes are arranged on the second wrapping portion of the sealing member at intervals along the circumferential direction of the sealing member.

In an optional solution for the cylindrical battery, a positioning pillar is provided on the sealing member, and a positioning hole through which the positioning pillar passes is provided on the cover.

In an optional solution for the cylindrical battery, the sealing member further includes a third wrapping portion, and the third wrapping portion is configured to connect the first wrapping portion and the second wrapping portion.

In an optional solution for the cylindrical battery, the protruding portion is provided on the peripheral side of the cover, and the avoidance hole is provided on the third wrapping portion of the sealing member.

In an optional solution for the cylindrical battery, a plurality of the protruding portions are arranged on the peripheral side of the cover at intervals along the circumferential direction of the cover, and a plurality of the avoidance holes are arranged on the third wrapping portion of the sealing member at intervals along the circumferential direction of the sealing member.

In an optional solution for the cylindrical battery, one end of the positioning pillar is connected to the first wrapping portion, and another end of the positioning pillar is spaced apart from the second wrapping portion.

In an optional solution for the cylindrical battery, one end of the positioning pillar is connected to the second wrapping portion, and another end of the positioning pillar is spaced apart from the first wrapping portion.

In an optional solution for the cylindrical battery, the first wrapping portion and the second wrapping portion are arranged at intervals, and a gap between the first wrapping portion and the second wrapping portion serves as the avoidance hole. Two ends of the positioning pillar are respectively connected to the first wrapping portion and the second wrapping portion. One of the protruding portions encloses the outer peripheral side of the cover, and the protruding portion passes through the avoidance hole.

In an optional solution for the cylindrical battery, the thickness of the protruding portion is greater than the thickness of the cover. In an optional solution for the cylindrical battery, the cylindrical battery further includes a first connecting piece, and the first connecting piece is configured to electrically connect the first tab and the cover.

In a second aspect, an electronic device is provided, which includes the above-mentioned cylindrical battery.

Compared with the related art, the advantageous effects of the present disclosure are as follows:

The cylindrical battery provided by the present disclosure includes a housing, a cell, a cover and a sealing member. The housing includes an end wall and a surrounding wall enclosing the end wall; the cell includes a cell body and a first tab, the cover is electrically connected to the first tab, and the cover is provided with a protruding portion. The sealing member is provided with an avoidance hole for the protruding portion to protrude from. The protruding portion on the cover is able to reach out through the avoidance hole on the sealing member to be in direct contact with the surrounding wall, thereby ensuring that the cover is electrically connected to the surrounding wall of the housing. In this way, it is possible to ensure the stability of the electrical connection between the cover and the housing without having to weld the cover and the housing. Also, the stability and safety of the cylindrical battery may be improved. In addition, the sealing member wraps the peripheral side of the cover to realize the sealing connection between the cover and the surrounding wall of the housing, and electrolyte leakage may be avoided.

The electronic device provided by the present disclosure is able to improve the stability and safety of the electronic device by using the above-mentioned cylindrical battery.

### BRIEF DESCRIPTION OF THE DRAWINGS

In order to more clearly illustrate the technical solutions in the embodiments of the present disclosure, the accompanying drawings that need to be used in the description of the embodiments of the present disclosure will be briefly described below. Clearly, the accompanying drawings in the following description are only some embodiments of the present disclosure. For those skilled in the art, other drawings can also be obtained according to the content of the embodiment and these drawings of the present disclosure without any inventive effort.

FIG. 1 is a schematic structural diagram of the first type of cylindrical battery provided in an embodiment of the present disclosure.

FIG. 2 is an enlarged view of position A in FIG. 1.

FIG. 3 is an exploded schematic diagram of a cover and a sealing member of the first type of cylindrical battery provided in an embodiment of the present disclosure.

FIG. 4 is a schematic structural diagram of the second type of cylindrical battery provided in an embodiment of the present disclosure.

FIG. 5 is an enlarged view of position B in FIG. 4.

FIG. 6 is an exploded schematic diagram of a cover and a sealing member of the second type of cylindrical battery provided in an embodiment of the present disclosure.

FIG. 7 is a schematic structural diagram of the third type of cylindrical battery provided in an embodiment of the present disclosure.

FIG. 8 is an enlarged view of position C in FIG. 7.

FIG. 9 is an exploded schematic diagram of a cover and a sealing member of the third type of cylindrical battery provided in an embodiment of the present disclosure.

FIG. 10 is a schematic structural diagram of the fourth type of cylindrical battery provided in an embodiment of the present disclosure.

FIG. 11 is an enlarged view of position D in FIG. 10.

FIG. 12 is an exploded schematic diagram of a cover and a sealing member of the fourth type of cylindrical battery provided in an embodiment of the present disclosure.

### DESCRIPTION OF THE EMBODIMENTS

In order to better describe the technical problem to be solved by the disclosure, the adopted technical solution and the achieved technical effect, the technical solution of the disclosure will be further described below in conjunction with the accompanying drawings and through specific implementation methods.

In the description of the present disclosure, unless otherwise clearly specified and limited, the terms “connected”, “linked” and “fixed” should be understood in a broad sense, for example, the above terms may refer to a fixed connection, a detachable connection, or integral formation; mechanical or electrical connection; direction connection or indirect connection through an intermediary; or the internal communication of two components or the interaction relationship between two components. Those of ordinary skill in the art can understand the specific meanings of the above terms in the present disclosure in specific situations.

In the present disclosure, unless otherwise clearly specified and limited, a first feature being “on” or “below” a second feature may indicate direct contact between the first and second features, and may also indicate that the first and second features are not in direct contact but are in indirect contact through another feature between them. Moreover, the first feature being “above”, “over” and “on” the second feature indicates that the first feature is directly above and obliquely above the second feature, or merely indicates that the first feature is at a level higher than the second feature. The first feature being “below”, “beneath” and “under” the second feature indicates that the first feature is directly below and obliquely below the second feature, or simply means that the first feature is at a level lower than the second feature.

In the description of the present disclosure, the orientation or positional relationship of the terms “upper”, “lower”, “left”, “right” is interpreted based on the orientation or positional relationship shown in the accompanying drawings, and are only for the convenience of description and simplification of operation. It does not indicate or imply that the device or element referred to must have a specific orientation, be constructed and operate in a specific orientation, and therefore should not be construed as limitation to the present disclosure. In addition, the terms “first” and “second” are only used for discrimination in description, and have no special meaning.

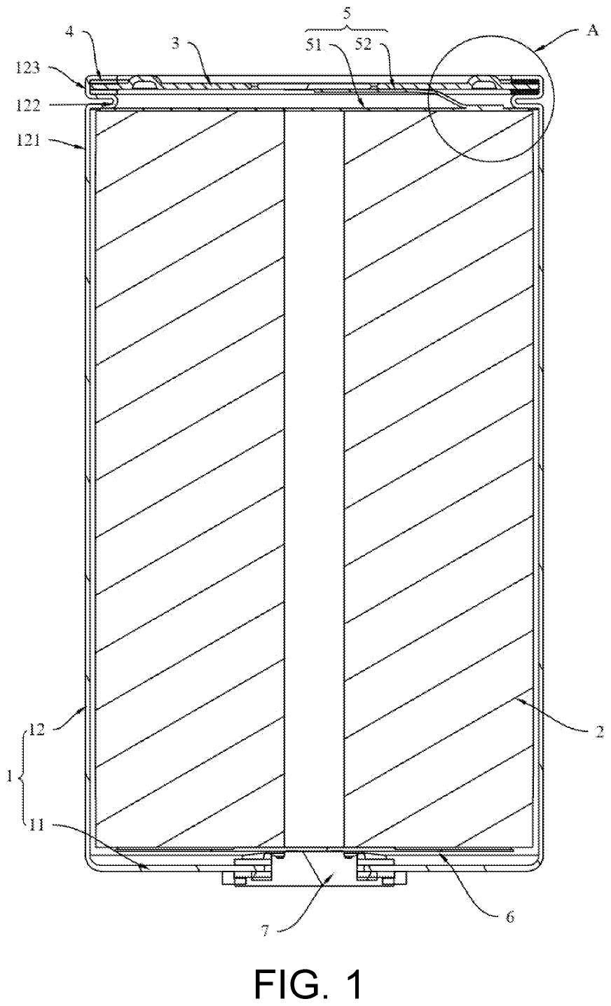

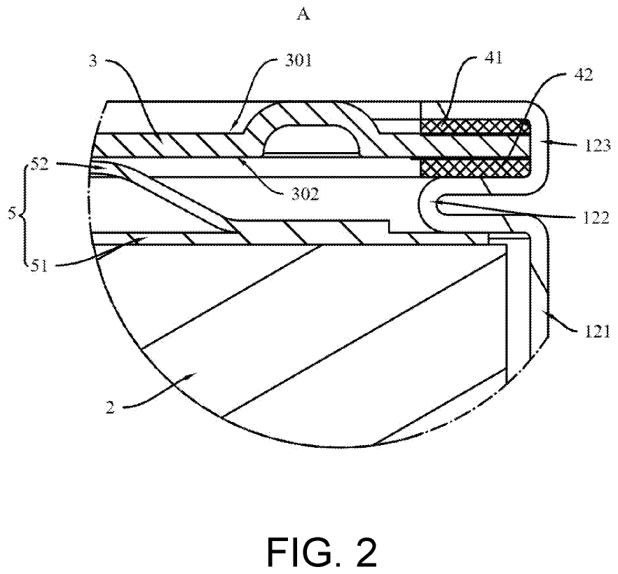

FIG. 1 shows a cross-sectional view of the first type of cylindrical battery provided in the present disclosure. FIG. 2 shows an enlarged view of position A in FIG. 1. As shown in FIG. 1 and FIG. 2, the cylindrical battery includes a housing 1, a cell 2, a cover 3, a sealing member 4, a first connecting piece 5, a second connecting piece 6 and an electrode pole 7. The housing 1 includes an opening, specifically, the housing 1 includes an end wall 11 and a surrounding wall 12, one end of the surrounding wall 12 is connected to the end wall 11, and the other end of the surrounding wall 12 forms the above-mentioned opening. The electrode pole 7 penetrates through the end wall 11 and is connected to the housing 1 in an insulated manner. The cell 2 is arranged in the housing 1, and the cover 3 is fixed on one end of the surrounding wall 12 away from the end wall 11 by adapting to the sealing member 4. The cell 2 includes a cell body, a first tab and a second tab. The first tab is located at one end of the cell body away from the end wall 11 of the housing 1, and the second tab is located at one end of the cell body close to the end wall 11 of the housing 1. The first tab is electrically connected to the cover 3 through the first connecting piece 5, and the second tab is electrically connected to the electrode pole 7 through the second connecting piece 6. The packaging process of the housing 1 and the cover 3 may be as follows: one end of the surrounding wall 12 of the housing 1 away from the end wall 11 is pier-sealed to form a main body portion 121 and a pier-sealed portion 122, then the sealing member 4 covers the peripheral side of the cover 3 to form a cover assembly, and the cover assembly is placed on the pier-sealed portion 122, and finally the surrounding wall 12 of the housing 1 is bent inwardly and fixed on the cover 3 to form the package portion 123, thereby completing packaging of the housing 1.

Further, as shown in FIG. 2, the first connecting piece 5 includes a first connecting portion 51 and a second connecting portion 52 connected to each other. The first connecting portion 51 is electrically connected to the first tab, and the second connecting portion 52 is electrically connected to the cover 3. Optionally, the shape of the first connecting portion 51 is disc-shaped, and one end of the second connecting portion 52 is welded to a peripheral area of the first connecting portion 51 close to the surrounding wall 12, and one end of the second connecting portion 52 is extended to the centre of the first connecting portion 51 and is welded to the cover 3. Of course, in other embodiments, the first connecting piece 5 may also be formed integrally, and formed on the first connecting portion 51 by punching.

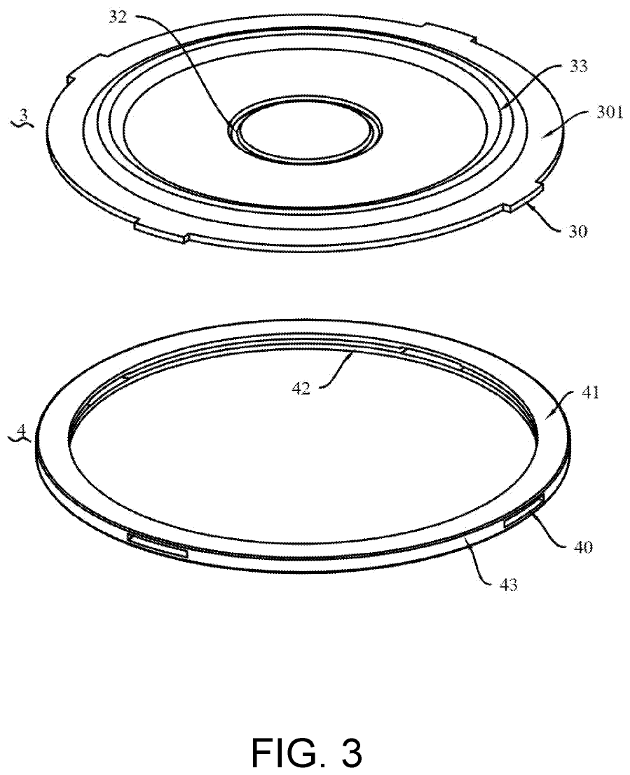

FIG. 3 is an exploded schematic diagram of a cover assembly of the first type of cylindrical battery provided in the present disclosure. As shown in FIG. 3 in conjunction with FIG. 2, the cover 3 is provided with a protruding portion 30, and the sealing member 4 is provided with an avoidance hole 40 for the protruding portion 30 to protrude from. The protruding portion 30 on the cover 3 is able to reach out through the avoidance hole 40 on the sealing member 4 to be in direct contact with the package portion 123 of the surrounding wall 12. In forming the cover assembly, on the one hand, the peripheral side of the cover 3 is wrapped through the sealing member 4, thereby realizing the sealing connection between the cover 3 and the surrounding wall 12 of the housing 1, and leakage of the electrolyte may be avoided; on the other hand, the cover 3 and the first tab are electrically connected, and then the protruding portion 30 of the cover 3 passes through the avoidance hole 40 on the sealing member 4 to be in direct contact with the package portion 123 of the surrounding wall 12, thereby ensuring that the cover 3 is electrically connected to the surrounding wall 12 of the housing 1. In this way, it is possible to ensure the stability of the electrical connection between the cover 3 and the housing 1 without having to weld the cover 3 and the housing 1. Also, the stability and safety of the cylindrical battery may be improved.

As shown in FIG. 3 in conjunction with FIG. 2, the sealing member 4 includes a first wrapping portion 41, a second wrapping portion 42 and a third wrapping portion 43. The first wrapping portion 41 covers the outer surface 301 of the cover 3, the second wrapping portion 42 covers the inner surface 302 of the cover 3, and the third wrapping portion 43 is configured for connecting the first wrapping portion 41 and the second wrapping portion 42. Exemplarily, the section of the sealing member 4 is formed in a C shape. When assembling the cover 3, the sealing member 4 covers the peripheral edge of the cover 3, and then the cover assembly is placed on the pier-sealed portion 122 of the housing 1. In this manner, it is possible to improve the assembly efficiency of the cover 3. In the meantime, since the sealing member 4 covers the edge of the cover 3, when the housing 1 is packaged, the sealing member 4 is not easily detached from the cover 3, thereby ensuring the airtightness effect of the cover 3 and the package portion 123 of the housing 1, and avoiding electrolyte leakage, thus improving the stability and safety of cylindrical batteries.

Further, as shown in FIG. 3, the protruding portion 30 is provided on the peripheral side of the cover 3, and the avoidance hole 40 is provided on the third wrapping portion 43 of the sealing member 4. Four protruding portions 30 are arranged on the peripheral side of the cover 3 at intervals along the circumferential direction of the cover 3. Four avoidance holes 40 are arranged on the third wrapping portion 43 of the sealing member 4 at intervals along the circumferential direction of the sealing member 4. When the sealing member 4 covers the edge of the cover 3, the protruding portion 30 is able to reach out through the avoidance hole 40. In addition, the cooperation of the protruding portion 30 and the avoidance hole 40 makes it possible to position the sealing member 4, thereby avoiding the deformation and dislocation of the sealing member 4 due to the pressing force when the cover 3 is packaged, and ensuring the airtightness effect of the sealing member 4 to avoid electrolyte leakage. Of course, in other embodiments, the number of protruding portions 30 and avoidance holes 40 is not limited to the above examples, and the number of protruding portions 30 and avoidance holes 40 may be set freely according to needs, and related details are not provided here. It should be noted that the greater the number of protruding portions 30, the more stable the electrical connection between the cover 3 and the surrounding wall 12 of the housing 1. However, as the number of avoidance holes 40 increases, the airtightness between the cover 3 and the surrounding wall 12 of the housing 1 is likely to decrease, so the number of the protruding portions 30 and avoidance holes 40 is preferably 3 to 20.

Further, as shown in FIG. 3, a pier-thinning groove 32 is provided on the cover 3. The pier-thinning groove 32 is annular, and the center of the pier-thinning groove 32 coincides with the center of the cover 3. Regarding the setting of the pier-thinning groove 32, in the first aspect, the pier-thinning groove 32 reduces the structural strength of the cover 3 at this position, so that an explosion-proof valve structure may be formed at the pier-thinning groove 32. When thermal imbalance occurs in the cylindrical battery, the pier-thinning groove 32 breaks and releases high-temperature gas to avoid battery explosion. Secondly, the pier-thinning groove 32 is able to reduce the weight of the cover 3, save materials, reduce material costs, and realize lightweight design of cylindrical batteries. The cover 3 is provided with a punching portion 33, the punching portion 33 is annular, the center of the punching portion 33 coincides with the center of the cover 3, and the punching portion 33 protrudes toward the outer surface 301 of the cover 3. The arrangement of the punching portion 33 makes it possible to improve the overall structural strength of the cover 3, and prevent the cover 3 from being deformed by force. Exemplarily, the cover 3 may be formed by punching a steel plate.

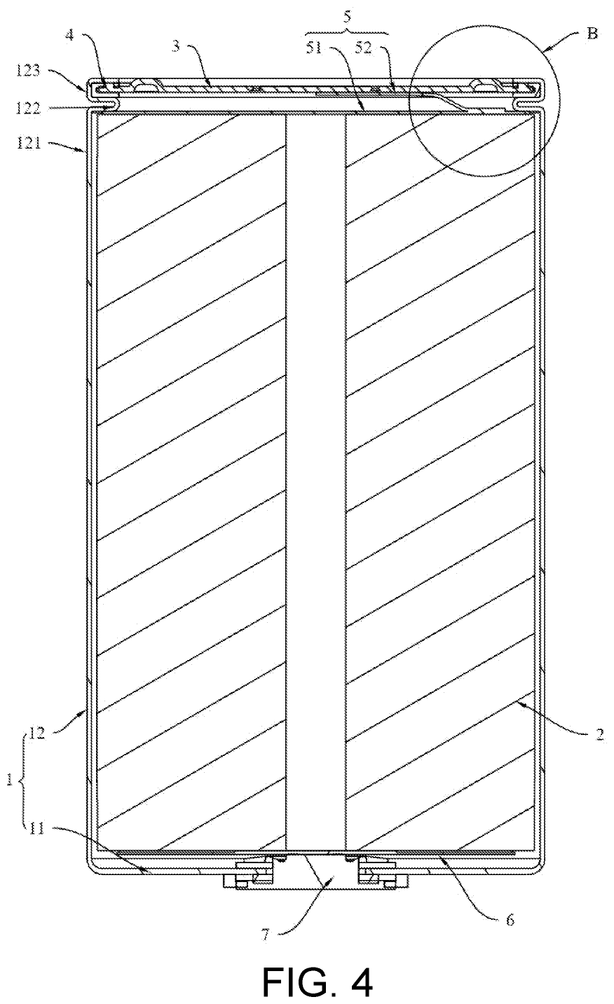

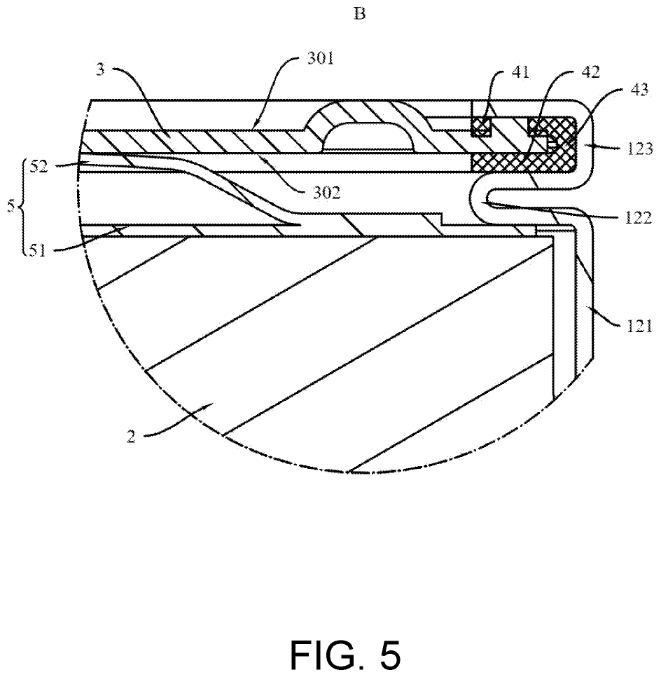

FIG. 4 shows a cross-sectional view of the second type of cylindrical battery provided in the present disclosure. FIG. 5 shows an enlarged view of position B in FIG. 4. As shown in FIG. 5 in conjunction with FIG. 4, the cylindrical battery includes a housing 1, a cell 2, a cover 3, a sealing member 4, a first connecting piece 5, a second connecting piece 6 and an electrode pole 7. The housing 1 includes an opening. Specifically, the housing 1 includes an end wall 11 and a surrounding wall 12, one end of the surrounding wall 12 is connected to the end wall 11, and the other end of the surrounding wall 12 forms the above-mentioned opening. The electrode pole 7 penetrates through the end wall 11 and is connected to the housing 1 in an insulated manner. The cell 2 is arranged in the housing 1, and the cover 3 is fixed on one end of the surrounding wall 12 away from the end wall 11 by adapting to the sealing member 4. The cell 2 includes a cell body, a first tab and a second tab. The first tab is located at one end of the cell body away from the end wall 11 of the housing 1, and the second tab is located at one end of the cell body close to the end wall 11 of the housing 1. The first tab is electrically connected to the cover 3 through the first connecting piece 5, and the second tab is electrically connected to the electrode pole 7 through the second connecting piece 6. The packaging process of the housing 1 and the cover 3 may be as follows: one end of the surrounding wall 12 of the housing 1 away from the end wall 11 is pier-sealed to form a main body portion 121 and a pier-sealed portion 122, then the sealing member 4 covers the peripheral side of the cover 3, and the assembly body of the cover 3 and the sealing member 4 is placed on the pier-sealed portion 122, and finally the surrounding wall 12 of the housing 1 is bent inwardly and fixed on the cover 3 to form the package portion 123, thereby completing packaging of the housing 1.

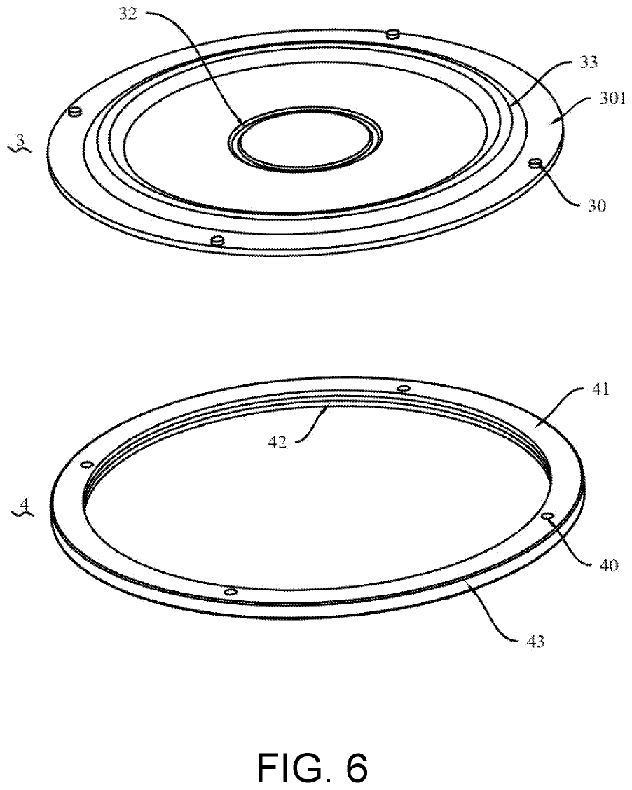

FIG. 6 shows an exploded schematic view of a cover assembly of the second type of cylindrical battery provided in the present disclosure. As shown in FIG. 6 in conjunction with FIG. 5, the cover 3 is provided with a protruding portion 30. The sealing member 4 is provided with an avoidance hole 40 for the protruding portion 30 to protrude from. The protruding portion 30 on the cover 3 is able to reach out through the avoidance hole 40 on the sealing member 4 to be in direct contact with the package portion 123 of the surrounding wall 12. In forming the cover assembly, on the one hand, the peripheral side of the cover 3 is wrapped through the sealing member 4, thereby realizing the sealing connection between the cover 3 and the surrounding wall 12 of the housing 1, and leakage of the electrolyte may be avoided; on the other hand, the cover 3 and the first tab are electrically connected, and then the protruding portion 30 of the cover 3 passes through the avoidance hole 40 on the sealing member 4 to be in direct contact with the package portion 123 of the surrounding wall 12, thereby ensuring that the cover 3 is electrically connected to the surrounding wall 12 of the housing 1. In this way, it is possible to ensure the stability of the electrical connection between the cover 3 and the housing 1 without having to weld the cover 3 and the housing 1. Also, the stability and safety of the cylindrical battery may be improved.

A pier-thinning groove 32 is provided on the cover 3. The pier-thinning groove 32 is annular, and the center of the pier-thinning groove 32 coincides with the center of the cover 3. Regarding the setting of the pier-thinning groove 32, in the first aspect, the pier-thinning groove 32 reduces the structural strength of the cover 3 at this position, so that an explosion-proof valve structure may be formed at the pier-thinning groove 32. When thermal imbalance occurs in the cylindrical battery, the pier-thinning groove 32 breaks and releases high-temperature gas to avoid battery explosion. Secondly, the pier-thinning groove 32 is able to reduce the weight of the cover 3, save materials, reduce material costs, and realize lightweight design of cylindrical batteries. The cover 3 is provided with a punching portion 33, the punching portion 33 is annular, the center of the punching portion 33 coincides with the center of the cover 3, and the punching portion 33 protrudes toward the outer surface 301 of the cover 3. The arrangement of the punching portion 33 makes it possible to improve the overall structural strength of the cover 3, and prevent the cover 3 from being deformed by force. Exemplarily, the cover 3 may be formed by punching a steel plate.

The similarity in the structures of the second type of cylindrical battery and the first type of cylindrical battery will not be repeated here, and the main difference between the two lies in: the cooperation between the sealing member 4 and the cover 3 is different. The details are as follows:

The sealing member 4 includes a first wrapping portion 41, a second wrapping portion 42 and a third wrapping portion 43. The first wrapping portion 41 covers the outer surface 301 of the cover 3, the second wrapping portion 42 covers the inner surface 302 of the cover 3, and the third wrapping portion 43 is configured to connect the first wrapping portion 41 and the second wrapping portion 42. Exemplarily, the section of the sealing member 4 is formed in a C shape. The protruding portion 30 is provided on the outer surface 301 of the cover 3, the avoidance hole 40 is arranged on the first wrapping portion 41 of the sealing member 4, and the protruding portion 30 passes through the avoidance hole 40 and then directly contacts the inner surface of the package portion 123 of the surrounding wall 12.

In FIG. 6, four protruding portions 30 are arranged on the outer surface 301 of the cover 3 at intervals along the circumferential direction of the cover 3. Four avoidance holes 40 are arranged on the first wrapping portion 41 of the sealing member 4 at intervals along the circumferential direction of the sealing member 4. When the sealing member 4 covers the edge of the cover 3, the protruding portion 30 is able to reach out through the avoidance hole 40. In addition, the cooperation of the protruding portion 30 and the avoidance hole 40 makes it possible to position the sealing member 4, thereby avoiding the deformation and dislocation of the sealing member 4 due to the pressing force when the cover 3 is packaged, and ensuring the airtightness effect of the sealing member 4 to avoid electrolyte leakage. Of course, in other embodiments, the number of protruding portions 30 and avoidance holes 40 is not limited to the above examples, and the number of protruding portions 30 and avoidance holes 40 may be set freely according to needs, and related details are not provided here. It should be noted that the greater the number of protruding portions 30, the more stable the electrical connection between the cover 3 and the surrounding wall 12 of the housing 1. However, as the number of avoidance holes 40 increases, the airtightness between the cover 3 and the surrounding wall 12 of the housing 1 is likely to decrease, so the number of the protruding portions 30 and avoidance holes 40 is preferably 3 to 20.

Further, as shown in FIG. 6, the protruding portion 30 is a cylindrical structure, and the avoidance hole 40 is a round through hole. In other embodiments, the protruding portion 30 may also have other shapes, which are not limited here.

Optionally, in other embodiments, a plurality of protruding portions 30 are arranged on the inner surface 302 of the cover 3 at intervals along the circumferential direction of the cover 3, and a plurality of avoidance holes 40 are arranged on the second wrapping portion 42 of the sealing member 4 at intervals along the circumferential direction of the sealing member 4. For the arrangement of the protruding portion 30 and the avoidance hole 40, reference may be made to the arrangement of the second type of cylindrical battery, and details will not be repeated here.

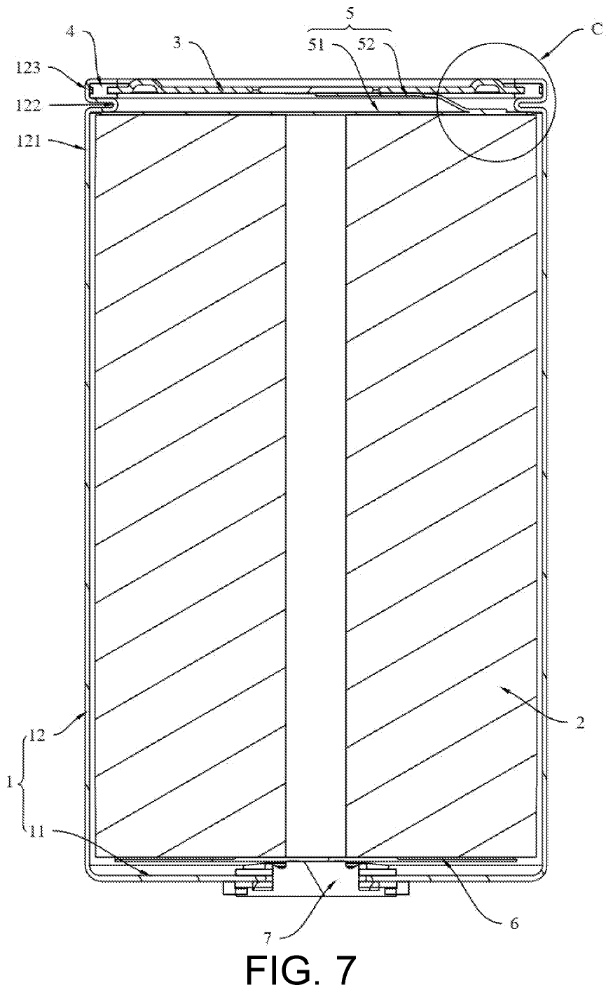

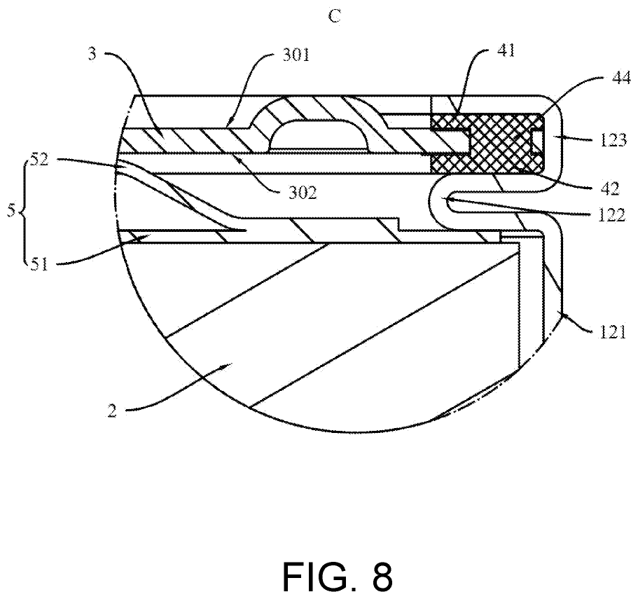

FIG. 7 is a cross-sectional view of the third type of cylindrical battery provided in the present disclosure. FIG. 8 is an enlarged view of position C in FIG. 7. As shown in FIG. 8 combined with FIG. 7, the cylindrical battery includes a housing 1, a cell 2, a cover 3, a sealing member 4, a first connecting piece 5, a second connecting piece 6 and an electrode pole 7. The housing 1 includes an opening, specifically, the housing 1 includes an end wall 11 and a surrounding wall 12, one end of the surrounding wall 12 is connected to the end wall 11, and the other end of the surrounding wall 12 forms the above-mentioned opening. The electrode pole 7 penetrates through the end wall 11 and is connected to the housing 1 in an insulated manner. The cell 2 is arranged in the housing 1, and the cover 3 is fixed on one end of the surrounding wall 12 away from the end wall 11 by adapting to the sealing member 4. The cell 2 includes a cell body, a first tab and a second tab. The first tab is located at one end of the cell body away from the end wall 11 of the housing 1, and the second tab is located at one end of the cell body close to the end wall 11 of the housing 1. The first tab is electrically connected to the cover 3 through the first connecting piece 5, and the second tab is electrically connected to the electrode pole 7 through the second connecting piece 6. The packaging process of the housing 1 and the cover 3 may be as follows: one end of the surrounding wall 12 of the housing 1 away from the end wall 11 is pier-sealed to form a main body portion 121 and a pier-sealed portion 122, then the sealing member 4 covers the peripheral side of the cover 3, and the assembly body of the cover 3 and the sealing member 4 is placed on the pier-sealed portion 122, and finally the surrounding wall 12 of the housing 1 is bent inwardly and fixed on the cover 3 to form the package portion 123, thereby completing packaging of the housing 1.

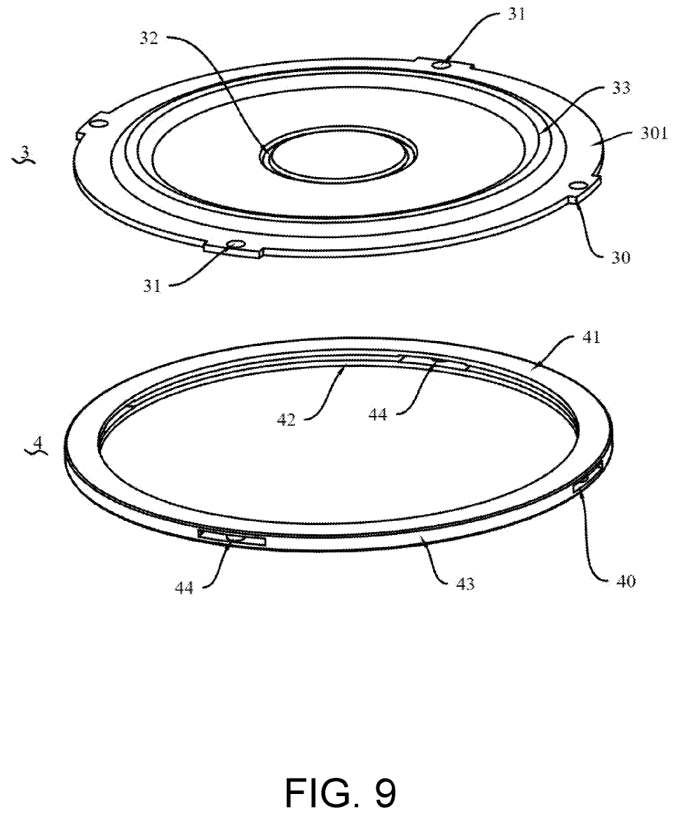

FIG. 9 is an exploded schematic diagram of a cover assembly of the third type of cylindrical battery provided in the present disclosure. As shown in FIG. 9 combined with FIG. 8, the cover 3 is provided with a protruding portion 30, and the sealing member 4 is provided with an avoidance hole 40 for the protruding portion 30 to protrude from. The protruding portion 30 on the cover 3 is able to reach out through the avoidance hole 40 on the sealing member 4 to be in direct contact with the package portion 123 of the surrounding wall 12. In forming the cover assembly, on the one hand, the peripheral side of the cover 3 is wrapped through the sealing member 4, thereby realizing the sealing connection between the cover 3 and the surrounding wall 12 of the housing 1, and leakage of the electrolyte may be avoided; on the other hand, the cover 3 and the first tab are electrically connected, and then the protruding portion 30 of the cover 3 passes through the avoidance hole 40 on the sealing member 4 to be in direct contact with the surrounding wall 12 of the housing 1, thereby ensuring that the cover 3 is electrically connected to the surrounding wall 12 of the housing 1. In this way, it is possible to ensure the stability of the electrical connection between the cover 3 and the housing 1 without having to weld the cover 3 and the housing 1. Also, the stability and safety of the cylindrical battery may be improved.

A pier-thinning groove 32 is provided on the cover 3. The pier-thinning groove 32 is annular, and the center of the pier-thinning groove 32 coincides with the center of the cover 3. Regarding the setting of the pier-thinning groove 32, in the first aspect, the pier-thinning groove 32 reduces the structural strength of the cover 3 at this position, so that an explosion-proof valve structure may be formed at the pier-thinning groove 32. When thermal imbalance occurs in the cylindrical battery, the pier-thinning groove 32 breaks and releases high-temperature gas to avoid battery explosion. Secondly, the pier-thinning groove 32 is able to reduce the weight of the cover 3, save materials, reduce material costs, and realize lightweight design of cylindrical batteries. The cover 3 is provided with a punching portion 33, the punching portion 33 is annular, the center of the punching portion 33 coincides with the center of the cover 3, and the punching portion 33 protrudes toward the outer surface 301 of the cover 3. The arrangement of the punching portion 33 makes it possible to improve the overall structural strength of the cover 3, and prevent the cover 3 from being deformed by force. Exemplarily, the cover 3 may be formed by punching a steel plate.

The arrangement of the protruding portion 30 and avoidance hole 40 in the third type of cylindrical battery is the same as that of the first type of cylindrical battery, and details will not be repeated here. The main difference between the two is that: the way of cooperation between the sealing member 4 and the cover 3 is different. The details are as follows:

The sealing member 4 includes a first wrapping portion 41, a second wrapping portion 42 and a third wrapping portion 43 connected in sequence. The first wrapping portion 41 covers the outer surface 301 of the cover 3, the second wrapping portion 42 covers the inner surface 302 of the cover 3, and the third wrapping portion 43 is configured to connect the first wrapping portion 41 and the second wrapping portion 42. Exemplarily, the section of the sealing member 4 is formed in a C shape. The cover 3 is provided with a positioning hole 31, the sealing member 4 is provided with a positioning pillar 44, and the positioning pillar 44 passes through the positioning hole 31 to further position the cover 3 and the sealing member 4.

Exemplarily, as shown in FIG. 8 and FIG. 9, one end of the positioning pillar 44 is connected to the first wrapping portion 41, and the other end of the positioning pillar 44 is connected to the second wrapping portion 42. In this way, the cover 3 and the sealing member 4 may be integrally formed by injection molding. Specifically, the cover 3 serves as an embedded member, and then the sealing member 4 is integrally formed on the cover 3 by using an injection mold to realize integral molding of the cover 3 and the sealing member 4, thereby improving the assembly efficiency of the cover assembly. Of course, in other embodiments, one end of the positioning pillar 44 is connected to the first wrapping portion 41, and the other end of the positioning pillar 44 is spaced apart from the second wrapping portion 42; or one end of the positioning pillar 44 is connected to the second wrapping portion 42, and the other end of the positioning pillar 44 is spaced apart from the first wrapping portion 41. In this manner, the integration of the cover 3 and the sealing member 4 may also be realized by wrapping the sealing member 4 on the edge of the cover 3 and manually inserting the positioning pillar 44 into the positioning hole 31 of the cover 3.

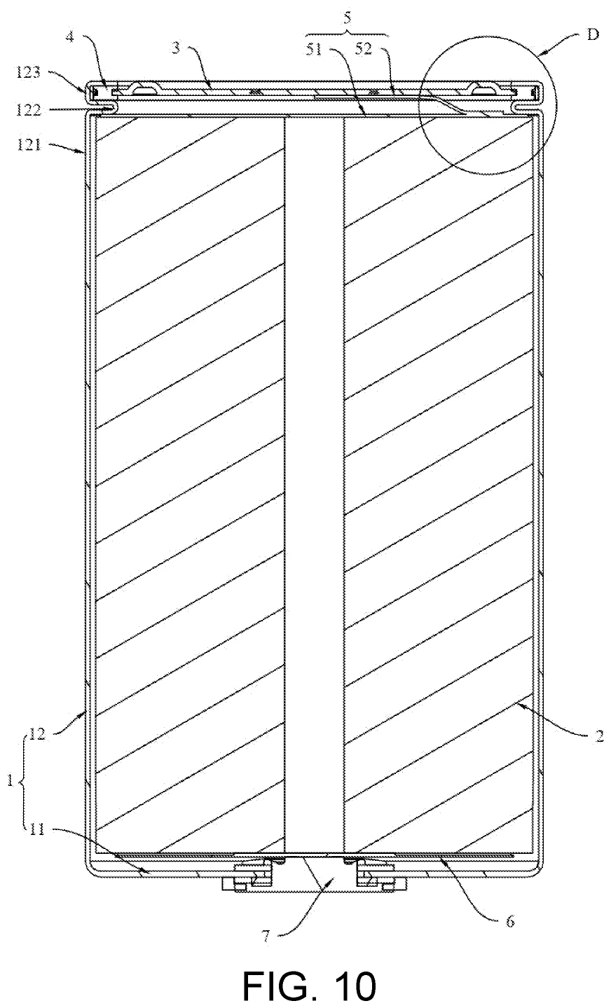

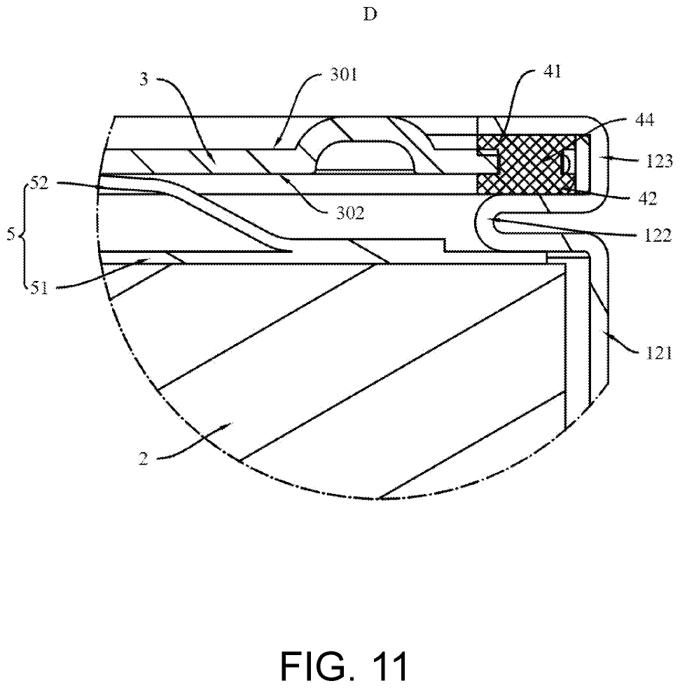

FIG. 10 shows a cross-sectional view of the fourth cylindrical battery provided in the present disclosure. FIG. 11 shows an enlarged view of position D in FIG. 10. As shown in FIG. 11 in combination with FIG. 10, the cylindrical battery includes a housing 1, a cell 2, a cover 3, a sealing member 4, a first connecting piece 5, a second connecting piece 6 and an electrode pole 7. The housing 1 includes an opening, specifically, the housing 1 includes an end wall 11 and a surrounding wall 12, one end of the surrounding wall 12 is connected to the end wall 11, and the other end of the surrounding wall 12 forms the above-mentioned opening. The electrode pole 7 penetrates through the end wall 11 and is connected to the housing 1 in an insulated manner. The cell 2 is arranged in the housing 1, and the cover 3 is fixed on one end of the surrounding wall 12 away from the end wall 11 by adapting to the sealing member 4. The cell 2 includes a cell body, a first tab and a second tab. The first tab is located at one end of the cell body away from the end wall 11 of the housing 1, and the second tab is located at one end of the cell body close to the end wall 11 of the housing 1. The first tab is electrically connected to the cover 3 through the first connecting piece 5, and the second tab is electrically connected to the electrode pole 7 through the second connecting piece 6. The packaging process of the housing 1 and the cover 3 may be as follows: one end of the surrounding wall 12 of the housing 1 away from the end wall 11 is pier-sealed to form a main body portion 121 and a pier-sealed portion 122, then the sealing member 4 covers the peripheral side of the cover 3, and the assembly body of the cover 3 and the sealing member 4 is placed on the pier-sealed portion 122, and finally the surrounding wall 12 of the housing 1 is bent inwardly and fixed on the cover 3 to form the package portion 123, thereby completing packaging of the housing 1.

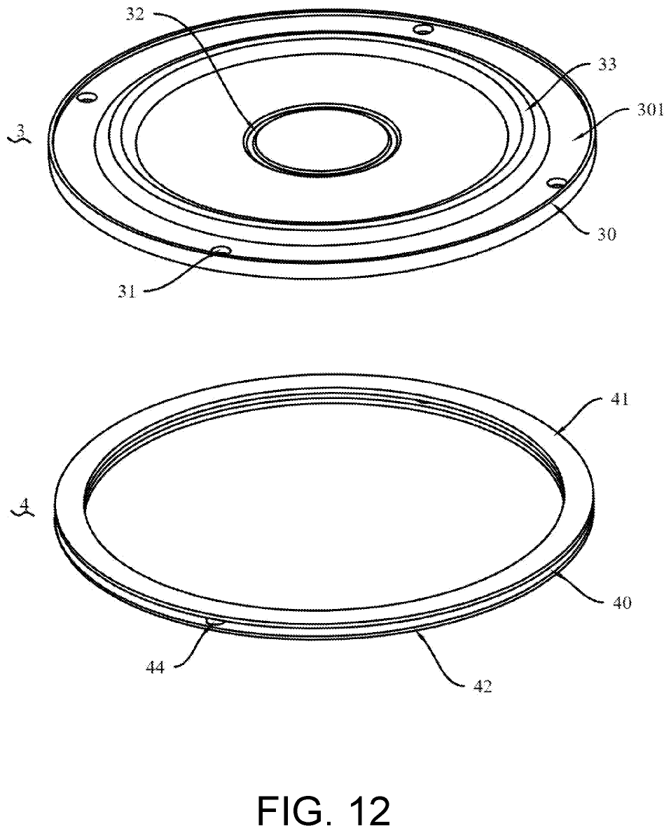

FIG. 12 is an exploded schematic diagram of a cover assembly of the fourth type of cylindrical battery provided in the present disclosure. As shown in FIG. 12 combined with FIG. 11, the cover 3 is provided with a protruding portion 30, and the sealing member 4 is provided with an avoidance hole 40 for the protruding portion 30 to protrude from. The protruding portion 30 on the cover 3 is able to reach out through the avoidance hole 40 on the sealing member 4 to be in direct contact with the package portion 123 of the surrounding wall 12. In forming the cover assembly, on the one hand, the peripheral side of the cover 3 is wrapped through the sealing member 4, thereby realizing the sealing connection between the cover 3 and the surrounding wall 12 of the housing 1, and leakage of the electrolyte may be avoided; on the other hand, the cover 3 and the first tab are electrically connected, and then the protruding portion 30 of the cover 3 passes through the avoidance hole 40 on the sealing member 4 to be in direct contact with the surrounding wall 12 of the housing 1, thereby ensuring that the cover 3 is electrically connected to the surrounding wall 12 of the housing 1. In this way, it is possible to ensure the stability of the electrical connection between the cover 3 and the housing 1 without having to weld the cover 3 and the housing 1. Also, the stability and safety of the cylindrical battery may be improved.

A pier-thinning groove 32 is provided on the cover 3. The pier-thinning groove 32 is annular, and the center of the pier-thinning groove 32 coincides with the center of the cover 3. Regarding the setting of the pier-thinning groove 32, in the first aspect, the pier-thinning groove 32 reduces the structural strength of the cover 3 at this position, so that an explosion-proof valve structure may be formed at the pier-thinning groove 32. When thermal imbalance occurs in the cylindrical battery, the pier-thinning groove 32 breaks and releases high-temperature gas to avoid battery explosion. Secondly, the pier-thinning groove 32 is able to reduce the weight of the cover 3, save materials, reduce material costs, and realize lightweight design of cylindrical batteries. The cover 3 is provided with a punching portion 33, the punching portion 33 is annular, the center of the punching portion 33 coincides with the center of the cover 3, and the punching portion 33 protrudes toward the outer surface 301 of the cover 3. The arrangement of the punching portion 33 makes it possible to improve the overall structural strength of the cover 3, and prevent the cover 3 from being deformed by force. Exemplarily, the cover 3 may be formed by punching a steel plate.

The main difference between the fourth type of cylindrical battery and the third type of cylindrical battery is that the structures of the sealing member 4 and the cover 3 are different. The details are as follows:

The sealing member 4 includes a first wrapping portion 41 and a second wrapping portion 42, the first wrapping portion covers the outer surface 301 of the cover 3, and the second wrapping portion 42 covers the inner surface 302 of the cover 3. The first wrapping portion 41 and the second wrapping portion 42 are substantially parallel to each other. The sealing member 4 further includes a positioning pillar 44, which is configured to connect the first wrapping portion 41 and the second wrapping portion 42 to ensure the integrity of the sealing member 4. The cover 3 and the sealing member 4 are integrally assembled by injection molding. Since the sealing member 4 covers the edge of the cover 3, when the housing 1 is packaged, the sealing member 4 is not easily detached from the cover 3, thereby ensuring the airtightness effect between the cover 3 and the package portion 123 of the housing 1, and avoiding electrolyte leakage, thus improving the stability and safety of cylindrical batteries.

Specifically, in this example, the number of the protruding portion 30 is one, and one protruding portion 30 is disposed around the peripheral side of the cover 3. The gap between the first wrapping portion 41 and the second wrapping portion 42 serves as an avoidance hole 40 for the protruding portion 30 to pass through. The thickness of the protruding portion 30 in the height direction of the battery is greater than that of the cover 3, thereby increasing the contact area between the protruding portion 30 and the package portion 123 of the surrounding wall 12, thus ensuring the stability of the electrical connection.

As shown in FIG. 12 in combination with FIG. 11, the protruding portion 30 is arranged perpendicular to the cover 3, and thus forming an inverted T shape. The first wrapping portion 41 and the second wrapping portion 42 of the sealing member 4 are connected and fixed through the positioning pillar 44, thereby ensuring the overall integrity of the sealing member 4.

In the fourth type of cylindrical battery, the airtightness effect of the sealing member 4 is mainly realized by the first wrapping portion 41 and the second wrapping portion 42 of the sealing member 4. In this example, the contact area between the protruding portion 30 of the cover 3 and the package portion 123 of the housing 1 is the largest, and the contact effect is the most stable, thereby effectively improving the stability of the electrical connection between the cover 3 and the housing 1.

The present disclosure further provides an electronic device, which includes the cylindrical battery. By using the cylindrical battery, the electronic device has high energy density and stable performance, and may improve user experience.

Optionally, the electronic device may be a power battery of a new energy vehicle, a new energy storage device, an electronic product, etc., which will not be described here in details.

Note that in the description of this present disclosure, some expressions such as “some embodiments”, “other embodiments” and the like mean that the specific features, structures, materials or characteristics described in conjunction with the embodiments or examples are included in at least one embodiment or example of the disclosure. In this present disclosure, schematic expression of the above terms do not necessarily refer to the same embodiment or example. Furthermore, the particular features, structures, materials or characteristics described may be combined in any suitable manner in any one or more embodiments or examples.

The above are only preferred embodiments of the present disclosure and technical principles applied in the disclosure. Those skilled in the art will understand that the present disclosure is not limited to the specific embodiments described here, and various obvious changes, readjustments and substitutions can be made by those skilled in the art without departing from the protection scope of the present disclosure. Therefore, although the present disclosure has been described in detail through the above embodiments, the present disclosure is not limited to the above embodiments, and can also include more other equivalent embodiments without departing from the concept of the present disclosure. The scope of the present disclosure is determined by the appended claims.

What is claimed is:

1. A cylindrical battery, comprising:
a housing, which comprises an opening;
a cell, which comprises a cell body and a first tab, wherein the first tab is located at one end of the cell body;
a cover, which is electrically connected to the first tab, wherein a protruding portion is provided on the cover;
a sealing member, which covers an edge of the cover, wherein the sealing member is provided with an avoidance hole for the protruding portion to protrude from, and the protruding portion on the cover is able to reach out through the avoidance hole on the sealing member to be in direct contact with the housing.

2. The cylindrical battery according to claim 1, wherein the sealing member comprises a first wrapping portion and a second wrapping portion, the first wrapping portion covers an outer surface of the cover, and the second wrapping portion covers an inner surface of the cover.

3. The cylindrical battery according to claim 2, wherein a plurality of the protruding portions are arranged on the outer surface of the cover at intervals along a circumferential direction of the cover, and a plurality of the avoidance holes are arranged on the first wrapping portion of the sealing member at intervals along a circumferential direction of the sealing member; or
the plurality of protruding portions are arranged on the inner surface of the cover at intervals along the circumferential direction of the cover, and the plurality of avoidance holes are arranged on the second wrapping portion of the sealing member at intervals along the circumferential direction of the sealing member.

4. The cylindrical battery according to claim 2, wherein a positioning pillar is provided on the sealing member, and a positioning hole through which the positioning pillar passes is provided on the cover.

5. The cylindrical battery according to claim 4, wherein the sealing member further comprises a third wrapping portion, and the third wrapping portion is configured to connect the first wrapping portion and the second wrapping portion.

6. The cylindrical battery according to claim 5, wherein the protruding portion is provided on a peripheral side of the cover, and the avoidance hole is provided on the third wrapping portion of the sealing member.

7. The cylindrical battery according to claim 6, wherein a plurality of the protruding portions are arranged on the peripheral side of the cover at intervals along a circumferential direction of the cover, and a plurality of the avoidance holes are arranged on the third wrapping portion of the sealing member at intervals along a circumferential direction of the sealing member.

8. The cylindrical battery according to claim 5, wherein one end of the positioning pillar is connected to the first wrapping portion, and another end of the positioning pillar is spaced apart from the second wrapping portion; or
one end of the positioning pillar is connected to the second wrapping portion, and another end of the positioning pillar is spaced apart from the first wrapping portion.

9. The cylindrical battery according to claim 6, wherein one end of the positioning pillar is connected to the first wrapping portion, and the other end thereof is spaced apart from the second wrapping portion; or
one end of the positioning pillar is connected to the second wrapping portion, and the other end thereof is spaced apart from the first wrapping portion.

10. The cylindrical battery according to claim 7, wherein one end of the positioning pillar is connected to the first wrapping portion, and the other end thereof is spaced apart from the second wrapping portion; or
one end of the positioning pillar is connected to the second wrapping portion, and the other end thereof is spaced apart from the first wrapping portion.

11. The cylindrical battery according to claim 4, wherein the first wrapping portion and the second wrapping portion are arranged at intervals, and a gap between the first wrapping portion and the second wrapping portion serves as the avoidance hole, two ends of the positioning pillar are respectively connected to the first wrapping portion and the second wrapping portion, one of the protruding portions encloses an outer peripheral side of the cover, and the protruding portion passes through the avoidance hole.

12. The cylindrical battery according to claim 9, wherein a thickness of the protruding portion is greater than a thickness of the cover.

13. An electronic device, comprising:
a cylindrical battery, comprising:
a housing, which comprises an opening;
a cell, which comprises a cell body and a first tab, wherein the first tab is located at one end of the cell body;
a cover, which is electrically connected to the first tab, wherein a protruding portion is provided on the cover;
a sealing member, which covers an edge of the cover, wherein the sealing member is provided with an avoidance hole for the protruding portion to protrude from, and the protruding portion on the cover is able to reach out through the avoidance hole on the sealing member to be in direct contact with the housing.
